(19) United States
(12) Patent Application Publication
(10) Pub. No.: US 2026/0244818 A1
(43) Pub. Date: Aug. 20, 2026

(54) DIGITAL TWIN PLATFORM SYSTEM AND DIGITAL TWIN PROVIDING METHOD

(71) Applicant: MITSUBISHI ELECTRIC CORPORATION, Tokyo (JP)

(72) Inventors: Hidematsu HAYASHI, Tokyo (JP); Yuki ITO, Tokyo (JP)

(73) Assignee: MITSUBISHI ELECTRIC CORPORATION, Tokyo (JP)

(21) Appl. No.: 19/159,330

(22) PCT Filed: Mar. 7, 2023
(86) PCT No.: PCT/JP2023/008620

§ 371 Date: Aug. 25, 2025

(51) Int. Cl. G06F 30/20

(52) U.S. Cl. CPC G06F 30/20

(57) ABSTRACT

A digital twin platform system includes: a real space; a virtual space; and a platform that provides a user with a digital twin to reproduce, in the virtual space, an asset existing in the real space. The platform includes: a data input and output unit that collects data about the asset existing in the real space; a program management unit that manages a program for implementing the digital twin; a digital twin execution unit that executes the program using the data collected, and implements one or more digital twins in one-to-one correspondence with one or more users; and a participant management unit that manages, individually for each unit in which use permission is settable, information about a participant allowed to use each of the data collected, the one or more digital twins implemented by the digital twin execution unit, and an execution result of the program.

### FIELD

The present disclosure relates to a digital twin platform system and a digital twin providing method for allowing a plurality of digital twins to be used by a plurality of users.

### BACKGROUND

In recent years, introduction of digital twins into the Factory Automation (FA) field has been studied. A digital twin refers to technology for collecting data from a real space that is a physical space region, and utilizing the collected data to reproduce the same space as the real space in a digital space.

For example, Patent Literature 1 discloses a technique of building a digital twin in which know-how of masters, which are skilled workers, is collected as data, and the collected data is used to reproduce skills of the masters in a virtual space.

### Citation List

### Patent Literature

Patent Literature 1: Japanese Patent No. 6926224

### SUMMARY OF INVENTION

### Problem to be solved by the Invention

The conventional digital twin has been limited to use within the same user having the digital twin. For example, a result of a simulation performed in a digital twin of a certain user has not been able to be shared with associated trading partner companies. For example, a facility manufacturer and a user of a facility have not been able to share a result of a simulation performed in a single digital twin and use the result to solve a problem occurring in the facility. That is, there has been no platform capable of sharing the digital twin.

The present disclosure has been made in view of the above circumstances, and an object of the present disclosure is to provide a digital twin platform system that allows the same digital twin to be used by a plurality of users.

### Means to Solve the Problem

In order to solve the above-described problems and achieve the object, a digital twin platform system according to the present disclosure includes: a real space that is a physical space region; a virtual space that is a virtual space region; and a platform to provide a user with a digital twin to reproduce, in the virtual space, an asset existing in the real space. The platform includes: a data input and output unit to collect data about the asset existing in the real space; a program management unit to manage, based on the data collected by the data input and output unit, a digital twin program for implementing the digital twin; a digital twin execution unit to execute the digital twin program using the data collected by the data input and output unit to implement one or more digital twins, each being identical to the digital twin, that are in one-to-one correspondence with one or more users; and a participant management unit to manage, individually for each unit in which use permission is settable, information about a participant allowed to use each of the data collected by the data input and output unit, the one or more digital twins implemented by the digital twin execution unit, and an execution result of the digital twin program.

### Effects of the Invention

The digital twin platform system according to the present disclosure has an effect of allowing the same digital twin to be used by the plurality of users.

### BRIEF DESCRIPTION OF DRAWINGS

FIG. 1 is a diagram illustrating an exemplary configuration of a digital twin system corresponding to a digital twin platform system according to an embodiment.

FIG. 2 is a diagram illustrating an arrangement example of a platform for implementing the digital twin system.

FIG. 3 is a diagram illustrating an example of a simulation execution position in the digital twin system.

FIG. 4 is a diagram illustrating an exemplary configuration of a platform for implementing the digital twin system.

FIG. 5 is a diagram conceptually illustrating a method by which a storage unit of a platform for implementing the digital twin system stores data.

FIG. 6 is a diagram illustrating an example of a data storage method performed by the storage unit of the platform for implementing the digital twin system.

FIG. 7 is a diagram illustrating an example of a data group stored in the storage unit of the platform for implementing the digital twin system, the data group being associated with a supplier.

FIG. 8 is a diagram illustrating an example of a data group stored in the storage unit of the platform for implementing the digital twin system, the data group being included in a common service.

FIG. 9 is a diagram illustrating a first example of a virtual space included in the digital twin system.

FIG. 10 is a diagram illustrating a second example of the virtual space included in the digital twin system.

FIG. 11 is a diagram illustrating a third example of the virtual space included in the digital twin system.

FIG. 12 is a diagram illustrating an example of a hardware configuration of the platform for implementing the digital twin system.

### DESCRIPTION OF EMBODIMENTS

Hereinafter, a digital twin platform system and a digital twin providing method according to an embodiment of the present disclosure will be described in detail with reference to the drawings.

### Embodiment

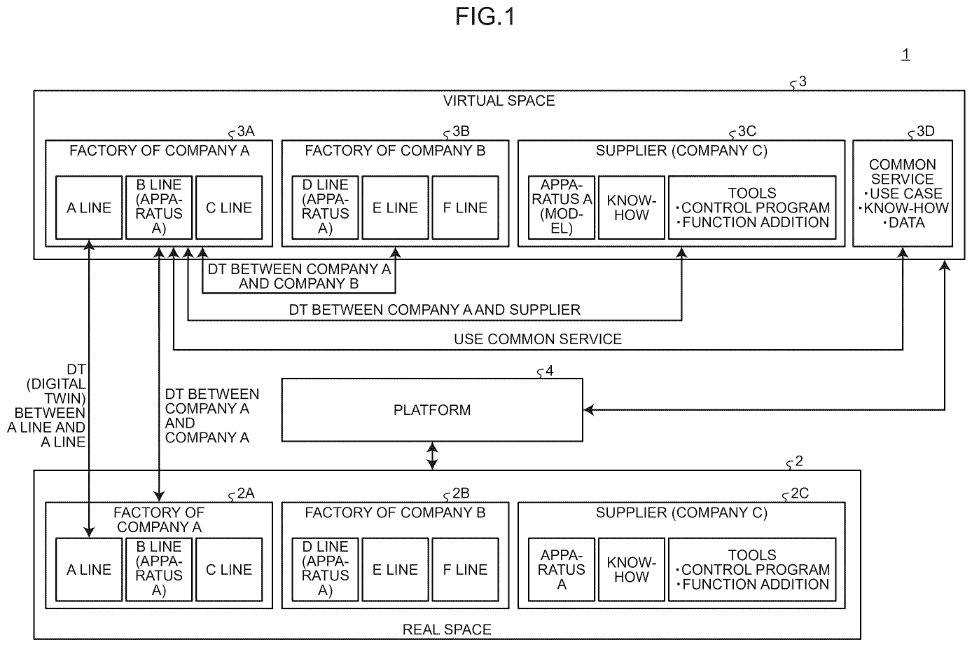

FIG. 1 is a diagram illustrating an exemplary configuration of a digital twin system 1 corresponding to a digital twin platform system according to an embodiment.

As illustrated in FIG. 1, the digital twin system 1 is a system for implementing a so-called digital twin by implementing assets existing in a real space 2 as electronic assets in a virtual space 3. The real space 2 is a physical space region. The assets are tangible objects such as manufacturing lines and facilities. The virtual space 3 is a virtual space region. The digital twin system 1 is configured by connecting the real space 2 to a platform 4. Specifically, the platform 4 collects, from the real space 2, data about assets existing in the real space 2, and based on the collected data, reproduces in the virtual space 3 the assets existing in the real space 2. Note that the virtual space is also referred to as a metaverse. In the illustration of FIG. 1, the virtual space 3 appears to exist independently outside the platform 4, but in practice, the virtual space 3 is built on the platform 4. Additionally, the platform 4 is connected to the real space 2 via a communication network or the like.

In the present embodiment, the term “digital twin” refers to technology in which the platform 4 collects data from the real space 2, and based on the collected data, reproduces in the virtual space 3 assets in a data collection source, that is, reproduces in the virtual space 3 the real space 2. Additionally, the expression “reproduces in the virtual space 3 the real space 2” refers to a simulation.

The platform 4 links the state of the assets existing in the real space 2 with the state of the assets reproduced in the virtual space 3. That is, the platform 4 continuously collects data from the real space 2, and based on the collected data, appropriately updates the state of the assets reproduced in the virtual space 3.

In the present embodiment, in the real space 2, for example, there exist a factory 2A of a company A, a factory 2B of a company B, and a supplier 2C (company C). The supplier 2C provides an apparatus and the like that operate in the company A and the company B. The factory 2A of the company A includes an A manufacturing line (which is illustrated as “A line” in FIG. 1, and the same applies hereinafter), a B manufacturing line, and a C manufacturing line, which are target lines of digital twins. The B manufacturing line includes an apparatus A provided by the supplier 2C. Similarly to the factory 2A of the company A, the factory 2B of the company B includes a D manufacturing line, an E manufacturing line, and an F manufacturing line. The D manufacturing line includes the apparatus A provided by the supplier 2C. The supplier 2C provides the apparatus A, know-how for appropriately operating the manufacturing lines, and tools (e.g., a control program for controlling the apparatus A, a function addition program for adding a function of the apparatus A, and the like). Note that the supplier 2C may provide the know-how and the tools to the factory 2A of the company A and the factory 2B of the company B through the intervention of a human operator in the real space 2, or may provide the know-how and the tools to the factory 2A of the company A and the factory 2B of the company B via the virtual space 3 to be described later.

The virtual space 3 includes, as electronic assets, a factory 3A of the company A, a factory 3B of the company B, and a supplier 3C that are respectively paired with the factory 2A of the company A, the factory 2B of the company B, and the supplier 2C, which exist in the real space 2. Additionally, the factory 3A of the company A in the virtual space 3 includes an A manufacturing line, a B manufacturing line, and a C manufacturing line that are paired with the respective manufacturing lines of the factory 2A of the company A in the real space 2; the factory 3B of the company B in the virtual space 3 includes a D manufacturing line, an E manufacturing line, and an F manufacturing line that are paired with the respective manufacturing lines of the factory 2B of the company B in the real space 2; and the supplier 3C in the virtual space 3 includes an apparatus A, know-how, tools, and the like that are paired with the respective assets owned by the supplier 2C in the real space 2. Furthermore, for example, the virtual space 3 includes, as a common service 3D provided by an operator of the digital twin system 1, a use case, know-how for effectively operating the manufacturing lines, and data for simulating the manufacturing lines of the factories.

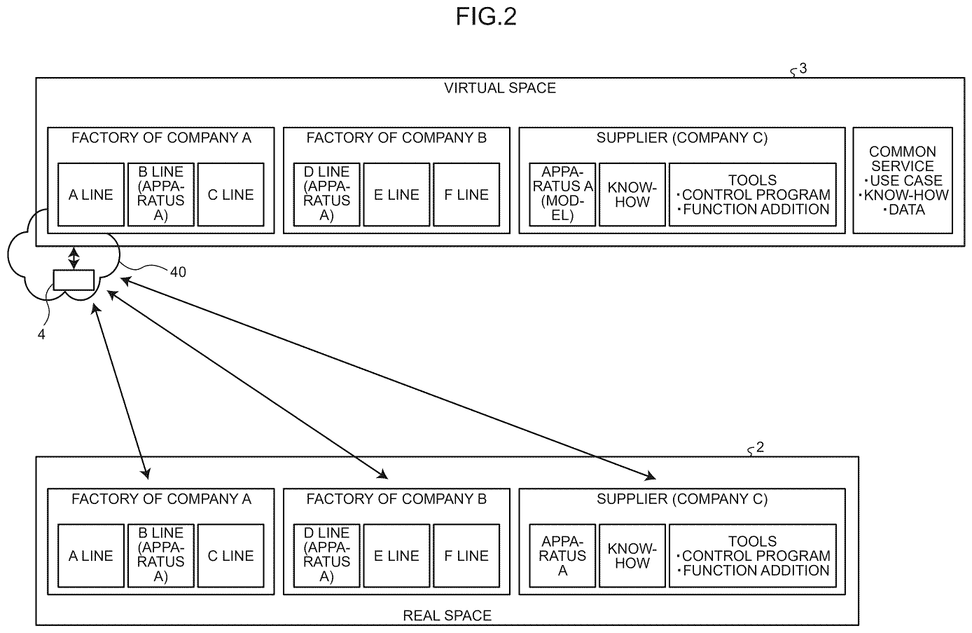

In the digital twin system 1, the virtual space 3 is provided on the platform 4, and the platform 4 is provided on a cloud 40 as illustrated in FIG. 2. The cloud 40 is connected to the factories and the supplier in the real space 2 via a network to provide data obtained from the real space 2 to the factories and the supplier in the virtual space 3 and also to provide data obtained from the virtual space 3 to the factories and the supplier in the real space 2. Incidentally, FIG. 2 is a diagram illustrating an arrangement example of the platform 4 for implementing the digital twin system 1.

For example, in the digital twin system 1, the platform 4 collects data from the facility of the A manufacturing line in the factory 2A of the company A in the real space 2, and using the collected data, simulates, in the factory 3A of the company A in the virtual space 3, the A manufacturing line. Similarly to the factory of the company A, the factory of the company B and the supplier are also allowed to use the digital twins.

Here, in the digital twin system 1 according to the present embodiment, when the factory of the company A and the factory of the company B agree to use the mutual virtual spaces 3, the factory of the company A and the factory of the company B can mutually use the virtual spaces 3 of the factory of the company A and the factory of the company B, that is, can use the mutual digital twins. At this time, the factory of the company A can use pieces of data of the factory of the company A and the factory of the company B collected by the platform 4. This allows the factory of the company A to perform a simulation from a desired viewpoint including the factory of the company A and the factory of the company B. For example, when the factory of the company A and the factory of the company B are associated in a supply chain, the factory of the company A can simulate the flow of production between the factory of the company A and the factory of the company B from the viewpoint of the factory of the company A. Similarly, the factory of the company A can also use the virtual space 3 and the common service 3D of the supplier.

On the other hand, the company C, which is the supplier, provides services for improving functions in the virtual spaces 3 of the factory of the company A and the factory of the company B. For example, the company C provides the factory of the company A with a model of the apparatus A, thus making it possible for the factory of the company A to use the model of the apparatus A to perform a simulation of the manufacturing line B including the apparatus A. Additionally, the company C provides the factory of the company A with know-how for efficiently operating the manufacturing lines, thus making it possible for the factory of the company A to confirm, through a simulation, an operation method for efficiently operating the manufacturing lines. Additionally, the company C provides the factory of the company A with the control program for controlling the apparatus A and the function addition program for improving the function of the apparatus A, thus making it possible for the factory of the company A to simulate the apparatus A, the function of which has been improved.

Additionally, the common service 3D provides a use case, know-how, shareable data, and the like. Here, the term “use case” refers to a simulation model, a simulation result, or the like, and the term “know-how” refers to knowledge of skilled workers or the like. For example, the common service 3D provides the factory of the company A with, as the use case, the simulation model or the simulation result, thus making it possible for the factory of the company A to establish an environment for a simulation of the manufacturing line at an early stage. Additionally, the common service 3D provides the factory of the company A with, as the know-how, knowledge of skilled workers who use the apparatus A, thus making it possible for the factory of the company A to effectively adjust the apparatus A. Additionally, the common service 3D provides the factory of the company A with shareable data, thus making it possible for the factory of the company A to use the provided data to perform a simulation in the established environment for the simulation of the manufacturing line.

That is, in the digital twin system 1, the factory of the company A, the factory of the company B, and the supplier each having the digital twin can share and use the digital twins held by trading partner companies after obtaining permission from the trading partner companies. Additionally, the digital twin system 1 is configured such that a plurality of digital twins is built on the platform 4 and among the digital twins, systems that have obtained permission operate in cooperation with each other. Furthermore, the digital twin system 1 is configured such that a simulation result in the virtual space 3 is reflected in the real space 2. Note that the reflection in the real space 2 includes not only reflection in the digital twins held by the companies, but also reflection in the real space 2 between the digital twins that operate in conjunction with each other when the digital twins held by the companies operate in conjunction with each other.

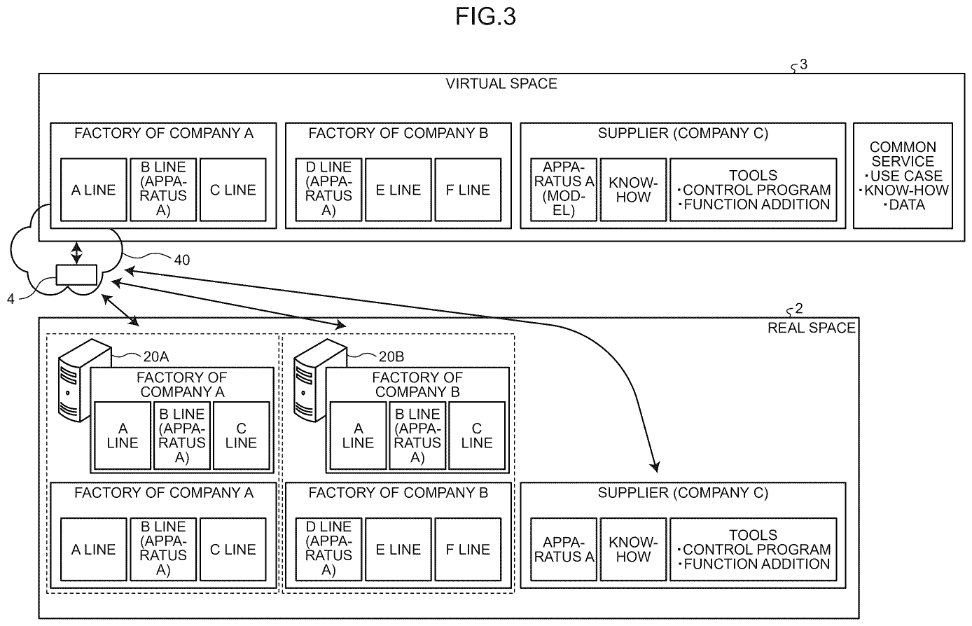

In the digital twin system 1, there are a case as illustrated in FIG. 2 where the virtual space 3 exists as a result of a simulation being performed on the cloud 40, and a case as illustrated in FIG. 3 where the virtual space 3 exists as a result of simulations being performed by simulation apparatuses 20A and 20B for digital twins installed in the factories of the respective companies, and on the cloud 40. Note that the simulation apparatus 20A is installed in the factory of the company A, and the simulation apparatus 20B is installed in the factory of the company B. FIG. 3 is a diagram illustrating an example of a simulation execution position in the digital twin system 1.

In the case of the configuration illustrated in FIG. 3, the result of simulations performed by the simulation apparatuses 20A and 20B is reflected on the cloud 40. The simulation apparatuses 20A and 20B cooperate with the cloud 40, and the reflection on the cloud 40 is performed by backing up the result of the simulations performed by the simulation apparatuses 20A and 20B on the cloud 40. When the digital twin of the factory of the company A and the digital twin of the factory of the company B cooperate with each other, that is, when mutual use of the digital twins is permitted between the factory of the company A and the factory of the company B, for example, upon backing up the result of the simulation performed by the simulation apparatus 20A on the cloud 40, the cloud 40 reflects the backed-up result of the simulation of the simulation apparatus 20A on the simulation apparatus 20B. This allows the simulation apparatus 20B to perform a simulation in consideration of the result of the simulation performed by the simulation apparatus 20A.

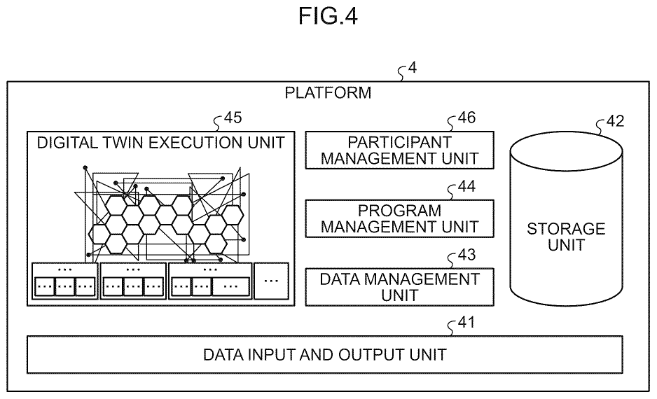

Here, the configuration of the platform 4 will be described. FIG. 4 is a diagram illustrating an exemplary configuration of the platform 4 for implementing the digital twin system 1. As illustrated in FIG. 4, the platform 4 includes a data input and output unit 41, a storage unit 42, a data management unit 43, a program management unit 44, a digital twin execution unit 45, and a participant management unit 46.

The data input and output unit 41 transmits and receives data to and from existing facilities and the like existing in the real space 2. The storage unit 42 stores data and the like used in the digital twin.

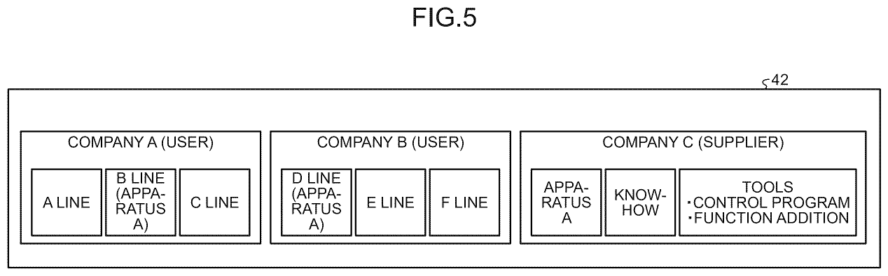

The data management unit 43 associates the data collected by the data input and output unit 41 from the real space 2 with an owner of the data and a data collection source, and stores the data in the storage unit 42. The owner of the data is, for example, the company A, and the data collection source is, for example, the apparatus A of the B manufacturing line in the factory of the company A. For example, as illustrated in FIG. 5, the storage unit 42 stores the received data in association with each of the company A, the company B, and the company C, which are the owners of data, and the manufacturing lines and the like, which are the data collection sources. FIG. 5 is a diagram conceptually illustrating a method by which the storage unit 42 of the platform 4 for implementing the digital twin system 1 stores data.

The program management unit 44 manages a digital twin program for executing a simulation using the data stored in the storage unit 42 to implement a digital twin.

The digital twin execution unit 45 provides each of users of the digital twin system 1 with a digital twin by executing a simulation using the data managed by the data management unit 43 and the digital twin program managed by the program management unit 44. Here, the term “users” refers to companies and the like that own assets in the real space 2 connected to the platform 4, and in the case of the configuration illustrated in FIG. 1, corresponds to the company A, the company B, and the company C.

The participant management unit 46 manages a participant who is allowed to use the digital twin implemented by the digital twin execution unit 45 executing the digital twin program managed by the program management unit 44. It is assumed that the participant managed by the participant management unit 46 can use an execution result of the digital twin program such as a simulation result, in addition to the use of the digital twin.

The platform 4, which is a software platform, determines whether which user is allowed to use which digital twin and the like based on the information about the participant managed by the participant management unit 46.

Each component of the platform 4 will be described in more detail.

The data input and output unit 41, upon receiving data from existing facilities and the like, transmits the received data to the data management unit 43. The existing facilities and the like are production facilities and the like existing in the real space 2. Additionally, after the digital twin execution unit 45 executes the simulation, the data input and output unit 41 transmits the result of the simulation to the facilities and the like in the real space 2. In this case, the result of the simulation includes parameter values for operating the facilities and the like. The data input and output unit 41 transmits the parameter values to the facilities and the like, and the facilities and the like operate based on the received parameter values, thereby enabling implementation of the digital twins.

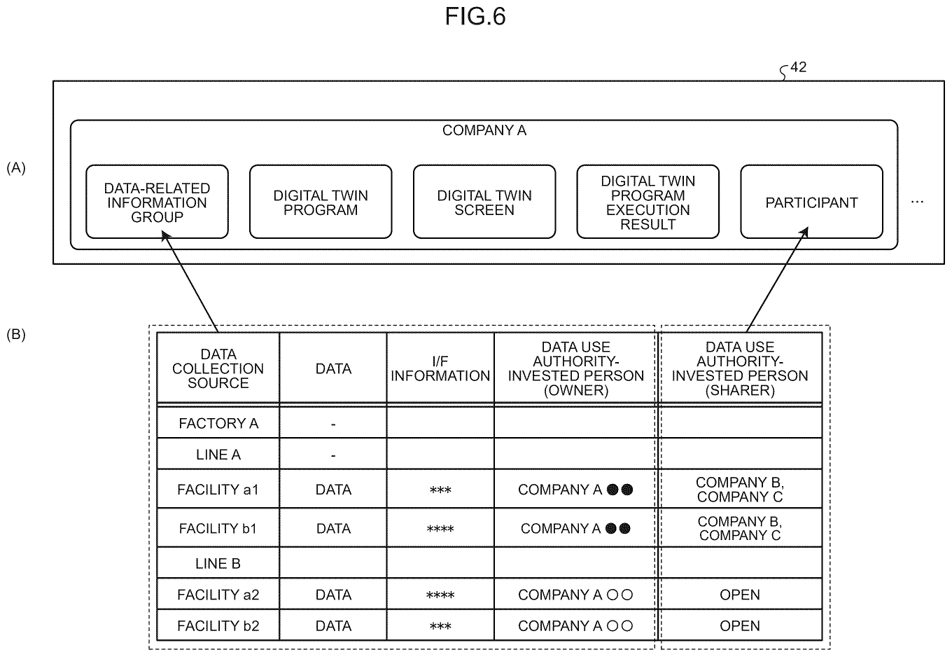

The storage unit 42 stores pieces of data and the like necessary for the data management unit 43, the program management unit 44, the digital twin execution unit 45, and the participant management unit 46. The storage unit 42 manages the pieces of data by storing the pieces of data, for example, as illustrated in (A) of FIG. 6. FIG. 6 is a diagram illustrating an example of a data storage method performed by the storage unit 42 of the platform 4 for implementing the digital twin system 1. As illustrated in (A) of FIG. 6, for example, as data related to the company A, the storage unit 42 stores, as a data-related information group, pieces of data (corresponding to “data” illustrated in (B) of FIG. 6), which are received from the data management unit 43 and related to the facilities and the like, acquired from the real space 2, of the company A, together with pieces of information (corresponding to “data collection source”, “I/F information”, and “data use authority-invested person (owner)” illustrated in (B) of FIG. 6) related to the pieces of data. The storage unit 42 also stores the digital twin program for the company A managed by the program management unit 44, and a digital twin screen, which is a screen for visually displaying the execution result of the digital twin program. The storage unit 42 also stores the execution result of the digital twin program executed by the digital twin execution unit 45.

The storage unit 42 also stores a participant who uses: the digital twin program; data necessary for program execution (hereinafter, such data may be referred to as “program execution data”); and the execution result of the digital twin program. The participant includes not only the company A, but also ones (e.g., company B and company C) for which the company A has permitted shared use of the digital twin program, the program execution data, and the digital twin program execution result. Note that the shared use may be permitted only for a part of the digital twin program, the program execution data, and the digital twin program execution result. A range for which the shared use is permitted may be set differently for each participant. For example, for a certain participant, only the digital twin program execution result may be permitted. In this way, when the shared use of the digital twin program and the like is permitted between one's own company and the trading partner companies, in the virtual space 3, it is possible to perform, for example, a simulation for final assembly of products manufactured by a plurality of persons in the respective factories or a simulation for an operation when one's own apparatus is installed in a manufacturing line of the trading partner company.

(B) of FIG. 6 illustrates configurations of the pieces of data and the like stored in the storage unit 42. The data-related information group includes the data collection source, the data acquired from the data collection source, the I/F information, which is identification information for using the data in a predetermined portion of the digital twin program, and the data use authority-invested person (owner) indicative of the owner of the data. The data use authority-invested person (owner) is invested with the authority to make the decision whether to grant the trading partner companies permission to use data. For example, in a facility a1, the company A ⋅⋅ is invested with the authority to make the decision whether to grant the trading partner companies permission to use data.

The “participant” associated with the company A illustrated in (A) of FIG. 6 includes a “data use authority-invested person (sharer)”, illustrated in (B) of FIG. 6, including information indicative of the trading partner companies to which permission to use data has been granted. For example, in the data use authority-invested person (sharer), when “company B and company C” are indicated, the company B and the company C are invested with the data use authority, and when “open” is indicated, a person who has accessed is invested with the data use authority on an access-by-access basis.

Upon receiving an access from the company B or the company C to the data-related information group associated with the company A, the data management unit 43 confirms, based on the data use authority-invested person (sharer) associated with the access-target data, whether the permission to use data has been granted. When having confirmed the permission, the data management unit 43 provides data to the access source (the company B or the company C). When not having confirmed the permission, the data management unit 43 does not provide the data to the access source.

Additionally, the data use authority-invested person (sharer) is also associated with the digital twin program and the digital twin program execution result. Upon receiving an access from the company B or the company C to the digital twin program or the digital twin program execution result, which is associated with the company A, the program management unit 44 confirms, based on the data use authority-invested person (sharer), whether the permission to use the digital twin program or the digital twin program execution result has been granted. When having confirmed the permission, the program management unit 44 allows the access source (the company B or the company C) to use the digital twin program or the digital twin program execution result. When not having confirmed the permission, the data management unit 43 does not allow the access source to use the digital twin program or the digital twin program execution result.

Note that similarly to the company A, also in the company B and the company C, the storage unit 42 stores a data-related information group and the like of each of the company B and the company C, and manages a data use authority-invested person (sharer) as a participant of each of the company B and the company C. In the above example described with reference to FIG. 6, when the data use authority-invested person (sharer) of the company A has the trading partner companies indicated therein, the trading partner companies are allowed to use the data and the like of the company A. However, as another example, only when the data use authority-invested person (sharer) each of a data user and a data owner has the mutual names indicated therein, the data and the like of the trading partner company are allowed to be used. This allows the mutual digital twins to be used between one's own company and the trading partner companies and the execution result of the digital twins to be shared therebetween, thus making it possible to prevent the reduction in the accuracy of the digital twins caused by the discrepancy of the data mutually usable by each other.

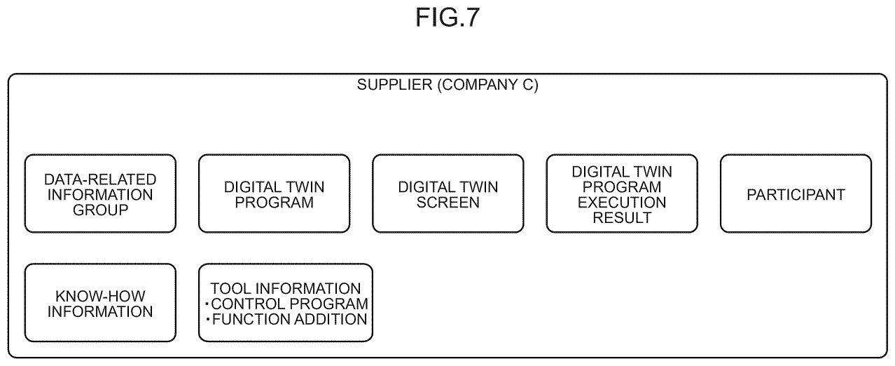

In addition to the above, as illustrated in FIG. 7, the data group associated with the company C, which is a supplier, is configured to enable the provision of know-how information and the provision of tool information. Here, the digital twin program, the digital twin screen, and the digital twin program execution result relate to the apparatus provided by the supplier, and the data-related information group is sample data for performing a simulation in the apparatus provided by the supplier. The know-how information is information for effectively implementing the digital twin, and examples thereof include a program example for a simulation, optimal parameter values, and the like. The tool information relates to the apparatus provided by the supplier, and includes a control program for controlling the apparatus (e.g., an upgraded version of a control program) and an additional function for enhancing the function of the apparatus (e.g., module software).

Note that the digital twin program, the digital twin screen, and the digital twin program execution result are updated so as to be compatible with an additional function when the additional function is applied to the apparatus, ensuring that in the digital twin, there is no difference in behavior between the virtual space 3 and the real space 2.

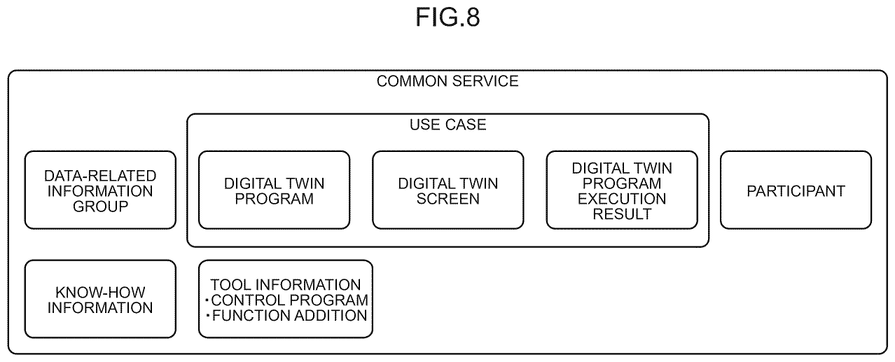

Additionally, as illustrated in FIG. 8, the common service has the same configuration as that in the data group associated with the supplier illustrated in FIG. 7. However, the digital twin program, the digital twin screen, and the digital twin program execution result are prepared as the use case. That is, the common service is configured to enable the implementation of a digital twin for a general-purpose apparatus. The know-how information and the tool information are also set as services for a general-purpose apparatus. Here, since the common service is a service for the person registered in the platform 4, the participant has, indicated therein, the person registered in the platform 4. Specifically, when a new person is registered in the platform 4, the participant management unit 46 allows the registered person to be indicated in the participant of the common service. This allows the person registered in the platform 4 to use the service of the common service.

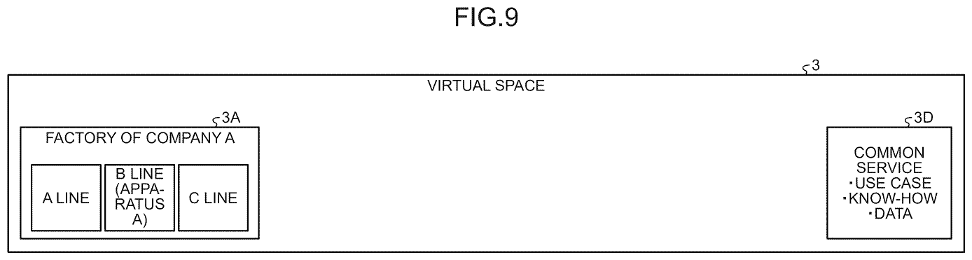

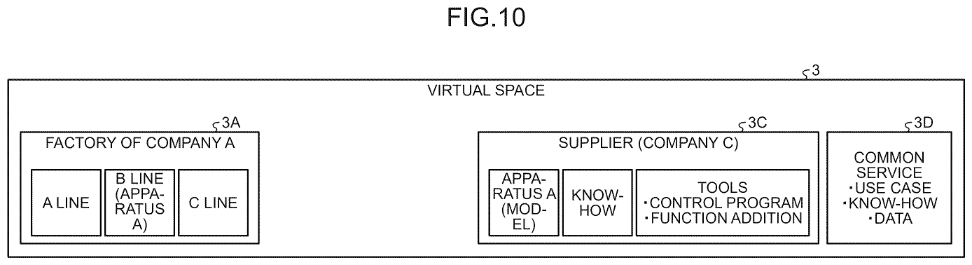

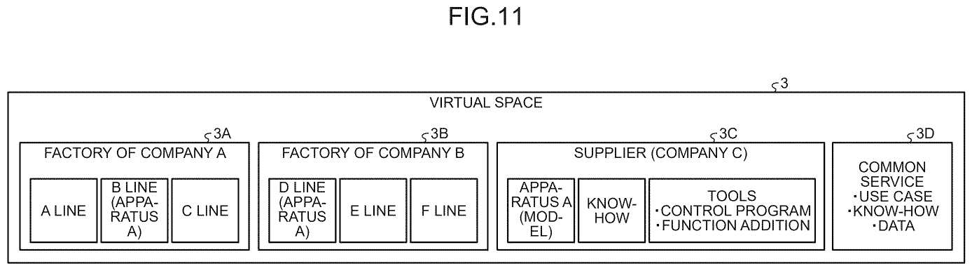

Next, an example of the virtual space 3 from the viewpoint of the company A will be described with reference to FIGS. 9 to 11. That is, as illustrated in FIGS. 9 to 11, the virtual space 3 is built on the platform 4. Note that FIG. 9 is a diagram illustrating a first example of the virtual space 3 included in the digital twin system 1, FIG. 10 is a diagram illustrating a second example of the virtual space 3 included in the digital twin system 1, and FIG. 11 is a diagram illustrating a third example of the virtual space 3 included in the digital twin system 1.

FIG. 9 illustrates a situation, in the virtual space 3, in which the company A can use only the common service 3D. That is, the company A implements a closed digital twin in the company A, and can use only the common service 3D of the platform 4 providing the digital twin, as appropriate. In this case, the participant (see FIG. 6) that is stored in the storage unit 42 of the platform 4 and associated with the company A has no data or only the common service indicated therein.

FIG. 10 illustrates a situation, in the virtual space 3, in which the company A can use the common service 3D and also receive provision of know-how and tools used by the company A from the supplier 3C. That is, the company A implements the digital twin using the service of the company C, which is a supplier providing the apparatus used by the company A, and can use only the common service 3D of the platform 4 providing the digital twin, as appropriate. In this case, the participant (see FIG. 6) that is stored in the storage unit 42 of the platform 4 and associated with the company A has, indicated therein, one or both of the supplier and the common service.

FIG. 11 illustrates a situation, in the virtual space 3, in which the company A and the company B cooperate with each other, and the company A and the company B can use the common service 3D and also receive provision of know-how and tools from the supplier 3C. That is, in addition to the state illustrated in FIG. 10, the company A shares the digital twin with the company B, enabling the implementation of the digital twin. In this case, the participant (see FIG. 6) that is stored in the storage unit 42 of the platform 4 and associated with the company A has, indicated therein, at least one of the company B, the supplier, or the common service.

Note that, in any of the cases of FIGS. 9 to 11, the participant management unit 46 manages the digital twin mutually usable by each other.

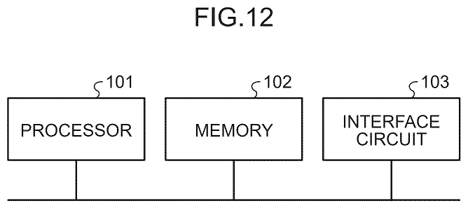

Next, an example of hardware of the foregoing platform 4 will be described. FIG. 12 is a diagram illustrating an example of a hardware configuration of the platform 4 for implementing the digital twin system 1.

The platform 4 can be implemented by, for example, a processor 101, a memory 102, and an interface circuit 103 illustrated in FIG. 12.

An example of the processor 101 includes a Central Processing Unit (CPU, which may also be referred to as a central processor, a processing unit, an arithmetic unit, a microprocessor, a microcomputer, or a Digital Signal Processor (DSP)) or a system Large Scale Integration (LSI). An example of the memory 102 includes a nonvolatile or volatile semiconductor memory such as a Random Access Memory (RAM), a Read Only Memory (ROM), or a flash memory, a magnetic disk, or the like. The interface circuit 103 is a circuit for allowing the platform 4 to exchange data with an external device having a communication function.

The data input and output unit 41 of the platform 4 is implemented by the interface circuit 103. Additionally, the storage unit 42 of the platform 4 is implemented by the memory 102.

The data management unit 43, the program management unit 44, the digital twin execution unit 45, and the participant management unit 46 of the platform 4 are implemented by the processor 101 executing programs for operating as these units. The programs for operating as the data management unit 43, the program management unit 44, the digital twin execution unit 45, and the participant management unit 46 are stored in the memory 102 in advance. The processor 101 reads the programs from the memory 102 and executes the programs, thereby operating as the data management unit 43, the program management unit 44, the digital twin execution unit 45, and the participant management unit 46.

The processor 101, the memory 102, and the interface circuit 103 illustrated in FIG. 12 may be hardware constituting an electronic computer. That is, the platform 4 of the digital twin system 1 may be implemented by an electronic computer and programs executed by the electronic computer. The platform 4 of the digital twin system 1 may be implemented by a plurality of electronic computers operating in cooperation.

As described above, the digital twin system 1 according to the present embodiment includes assets that exist in the real space 2 and output data necessary for implementing the digital twin, and the platform 4 that collects the data necessary for implementing the digital twin from the assets existing in the real space 2, and based on the collected data, reproduces, in the virtual space 3, each asset as the data collection source. The platform 4 includes the data input and output unit 41 that collects data from the real space 2, the data management unit 43 that manages the data collected from the real space 2 in association with the data collection source, the digital twin execution unit 45 that provides the users of the digital twin system 1 with the digital twins, and the participant management unit 46 that manages information about the participant who is allowed to use each of the data collected from the real space 2, the digital twin built for each user, and the execution result of the digital twin program. The digital twin system 1 determines, based on the user information managed by the participant management unit 46, whether to allow the user to use the data collected from the real space 2, the digital twin built for each user, and the execution result of the digital twin program.

The digital twin system 1 according to the present embodiment allows the digital twin to be shared among a plurality of users (predetermined participants among a manufacturer, a supplier of an apparatus used by the manufacturer, and the like), and the digital twins of different users to be cooperated with each other. Additionally, the know-how, the data, the use case, and the like can be shared among a plurality of participants via a plurality of digital twins.

Note that in the present embodiment described above, the user sharing the digital twin is a company such as a manufacturer, but the user sharing the digital twin may include an individual.

The features illustrated in connection with the above embodiment are illustrative only, and may be combined with other known techniques, or may partially be omitted or changed without going beyond the scope.

### REFERENCE SIGNS LIST

1 digital twin system; 2 real space; 2A, 3A factory of company A; 2B, 3B factory of company B; 2C, 3C supplier; 3 virtual space; 3D common service; 4 platform; 40 cloud; 41 data input and output unit; 42 storage unit; 43 data management unit; 44 program management unit; 45 digital twin execution unit; 46 participant management unit.

1. A digital twin platform system comprising:
a real space that is a physical space region;
a virtual space that is a virtual space region; and
a platform to provide a user with a digital twin to reproduce, in the virtual space, an asset existing in the real space, wherein
the platform includes:
a data input and output circuitry to collect data about the asset existing in the real space;
a program management circuitry to manage, based on the data collected by the data input and output circuitry, a digital twin program for implementing the digital twin;
a digital twin execution circuitry to execute the digital twin program using the data collected by the data input and output circuitry to implement one or more digital twins, each being identical to the digital twin, that are in one-to-one correspondence with one or more users; and
a participant management circuitry to manage, individually for each unit in which use permission is settable, information about a participant allowed to use each of the data collected by the data input and output circuitry, the one or more digital twins implemented by the digital twin execution circuitry, and an execution result of the digital twin program, wherein
when updating the digital twin in which a plurality of the participants allowed to use exists, out of the one or more digital twins, the digital twin execution circuitry simultaneously updates the digital twin that is available to each of the participants allowed to use the digital twin to be updated and is other than the digital twin to be updated, and allows two or more of the one or more digital twins in which a same user of the one or more users is set as the participant to cooperate with each other.

2. (canceled)

3. The digital twin platform system according to claim 1, wherein
when the digital twin execution circuitry performs a simulation of the asset reproduced in the virtual space, the asset existing in the real space is updated based on a result of performing the simulation.

4. The digital twin platform system according to claim 3, wherein
the digital twin execution circuitry performs, in the virtual space, a simulation of a facility included in the asset existing in the real space to obtain an operating parameter value of the facility, and applies the operating parameter value obtained to the facility existing in the real space.

5. The digital twin platform system according to claim 1, wherein
the one or more users are each a business operator having a factory or a supplier to provide an apparatus operating in the factory, and the supplier is configured to be able to provide the business operator with a service for improving a function of an asset of the business operator reproduced in the virtual space.

6. The digital twin platform system according to claim 5, wherein
the service includes a simulation model and a simulation result.

7. A digital twin platform system comprising:
a real space that is a physical space region;
a virtual space that is a virtual space region; and
a platform to provide a user with a digital twin to reproduce, in the virtual space, an asset existing in the real space, wherein
the platform includes:
a data input and output circuitry to collect data about the asset existing in the real space;
a program management circuitry to manage, based on the data collected by the data input and output circuitry, a digital twin program for implementing the digital twin;
a digital twin execution circuitry to execute the digital twin program using the data collected by the data input and output circuitry to implement one or more digital twins, each being identical to the digital twin, that are in one-to-one correspondence with one or more users; and
a participant management circuitry to manage, individually for each unit in which use permission is settable, information about a participant allowed to use each of the data collected by the data input and output circuitry, the one or more digital twins implemented by the digital twin execution circuitry, and an execution result of the digital twin program, wherein
an operator of the digital twin platform system is configured to be able to provide the one or more users with a common service available to all the one or more users.

8. A digital twin platform system comprising:
a real space that is a physical space region;
a virtual space that is a virtual space region; and
a platform to provide a user with a digital twin to reproduce, in the virtual space, an asset existing in the real space, wherein
the platform includes:
a data input and output circuitry to collect data about the asset existing in the real space;
a program management circuitry to manage, based on the data collected by the data input and output circuitry, a digital twin program for implementing the digital twin;
a digital twin execution circuitry to execute the digital twin program using the data collected by the data input and output circuitry to implement one or more digital twins, each being identical to the digital twin, that are in one-to-one correspondence with one or more users; and
a participant management circuitry to manage, individually for each unit in which use permission is settable, information about a participant allowed to use each of the data collected by the data input and output circuitry, the one or more digital twins implemented by the digital twin execution circuitry, and an execution result of the digital twin program, wherein
two or more of the one or more users for which mutual use of the asset reproduced in the virtual space is permitted are configured to be able to implement the one or more digital twins in cooperation with each other.

9. A digital twin providing method performed by a digital twin system including:
a real space that is a physical space region;
a virtual space that is a virtual space region; and
a platform to provide a user with a digital twin to reproduce, in the virtual space, an asset existing in the real space, the digital twin providing method comprising:
collecting, by a data input and output circuitry of the platform, data about the asset existing in the real space;
managing, by a program management circuitry of the platform, based on the data collected by the data input and output circuitry, a digital twin program for implementing the digital twin;
executing, by a digital twin execution circuitry of the platform, the digital twin program using the data collected by the data input and output circuitry to implement one or more digital twins, each being identical to the digital twin, that are in one-to-one correspondence with one or more users; and
managing, by a participant management circuitry of the platform, individually for each unit in which use permission is settable, information about a participant allowed to use each of the data collected by the data input and output circuitry, the one or more digital twins implemented by the digital twin execution circuitry, and an execution result of the digital twin program, wherein
when updating the digital twin in which a plurality of the participants allowed to use exists, out of the one or more digital twins, the digital twin execution circuitry simultaneously updates the digital twin that is available to each of the participants allowed to use the digital twin to be updated and is other than the digital twin to be updated, and allows two or more of the one or more digital twins in which a same user of the one or more users is set as the participant to cooperate with each other.

10. (canceled)

11. The digital twin providing method according to claim 9, wherein
when the digital twin execution circuitry performs a simulation of the asset reproduced in the virtual space, the asset existing in the real space is updated based on a result of performing the simulation.

12. The digital twin providing method according to claim 11, wherein
the digital twin execution circuitry performs, in the virtual space, a simulation of a facility included in the asset existing in the real space to obtain an operating parameter value of the facility, and applies the operating parameter value obtained to the facility existing in the real space.

13. The digital twin platform system according to claim 3, wherein
the one or more users are each a business operator having a factory or a supplier to provide an apparatus operating in the factory, and the supplier is configured to be able to provide the business operator with a service for improving a function of an asset of the business operator reproduced in the virtual space.

14. The digital twin platform system according to claim 4, wherein
the one or more users are each a business operator having a factory or a supplier to provide an apparatus operating in the factory, and the supplier is configured to be able to provide the business operator with a service for improving a function of an asset of the business operator reproduced in the virtual space.

15. The digital twin platform system according to claim 13, wherein
the service includes a simulation model and a simulation result.

16. The digital twin platform system according to claim 14, wherein the service includes a simulation model and a simulation result.
